(19) United States
(12) Patent Application Publication
(10) Pub. No.: US 2009/0210578 A1
(43) Pub. Date: Aug. 20, 2009

(54) Apparatus of TCP/IP offload engine and method for transferring packet using the same

(75) Inventors: Sang-Hwa Chung, Busan (KR); In-Su Yoon, Busan (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: Pusan National University Industry-University Cooperation Foundation

(21) Appl. No.: 12/320,910

(22) Filed: Feb. 9, 2009

(30) Foreign Application Priority Data
Feb. 20, 2008 (KR) 10-2008-0015294

(51) Int. Cl. G06F 13/00; G06F 3/00

(52) U.S. Cl. 710/22; 710/314

(57) ABSTRACT

A TOE apparatus and a method for transferring a packet applying the TOE have developed. the device comprises that an embedded processor for receiving information on an address and size of physical memory and generating a prototype header according to contents of the received information; and Gigabit Ethernet for generating header information of a packet using the prototype header, receiving data according to the address and size of the physical memory included in the information received from a host device through a main PCI bus, a PCI-to-PCI bridge, and a sub PCI bus, and adding the header information to the data, so as to transmit the data to a network.

### BACKGROUND OF THE INVENTION

1. Field of the Invention

The present invention relates to a method for processing TCP/IP protocols of computer network protocols on a network adapter embedded in a computer, in which the network adapter for processing the TCP/IP is referred as a TCP/IP Offload Engine (TOE). More particularly, the present invention relates to a TOE apparatus and a method for transferring a packet using the same which can transfer data without copying the data to an internal memory of the TOE upon transferring the data so as to achieve high capability of the TOE.

2. Description of the Prior Art

As network speeds increase to Gigabit Ethernet and 10 Gigabit Ethernet speeds, a host processor uses more CPU cycles for computing TCP/IP protocol stacks rather than performing actual process. Especially, there occurs tremendous performance deterioration in iSCSI (IP SAN) for transferring storage data through the IP due to an over-header of the TCP/IP.

Therefore, as a method for reducing burden of the CPU in processing a large amount of IP networking, a TCP/IP Offload Engine (TOE) technology of implementing the TCP/IP function with the hardware has been in the spotlight. The TOE can be referred to as a TCP/IP accelerator in which the Network Interface Card (NIC) hardware handles the load for processing the TCP/IP packet on the CPU.

FIGS. 1 and 2 are diagrams illustrating the packet transmission using a conventional TOE (INIC). First, FIG. 1 is a diagram specifically illustrating the TOE by Alacritech Inc. Hereinafter, a scheme of transferring data using the INIC will be described with reference to FIG. 1.

First, the INIC Direct Memory Access(DMA)es data to be transferred through a PCI bus 30 connected to a host device, e.g. a host computer, to a DRAM region 40 using an interior DMA controller 20. Here, the data having a larger size than that of a packet is split into the data unit having the packet size to be DMA'ed. Further, a packet header is generated in an SRAM region 41, and the packet header in the SRAM region 41 is added to a header of the (packet) data generated in the DRAM region 40 through the DMA transfer for generating a complete single packet. Such generated packets are transferred to any one of transmission queues 50, 51, 52, and 53 installed in the INIC and finally transferred to the network through MAC interfaces 60, 61, 62, and 63 being a pair with the transmission queues 50, 51, 52, and 53.

In the described data transmission scheme, the data to be transmitted through the PCI bus 30 connected to the host device is copied to the DRAM region 40 of the inside of the TOE so as to increase the time required for transmitting the packet to the network by the TOE, thereby causing the problem of time delays and deterioration of bandwidth performance.

In the meantime, FIG. 2 is a diagram illustrating the TOE by The Electronics and Telecommunications Research Institute, which solves the problem of FIG. 1.

As shown in FIG. 2, user area data of a host device is stored in a virtual sequential memory area 100. The virtual memory area 100 is mapped on a physical memory area 110 being separated in actual. The TOE generates a list 120 including information on an address and a size of the actual (physical) memory so as to transmit them to the TOE 130 when transmitting the data of the user area, without copying the data to a kernel area of the host device. Thereafter, the TOE receiving the list 120 DMA transfers the data stored in the physical memory area 110 separated in actual to the internal memory 140 of the TOE.

Such a scheme still has a problem in that the data of the user area of the host device is not copied to the kernel area of the host device, but is copied to the internal memory of the TOE, which causes an increase of the time required for transmitting the packet to the network by the TOE, time delays, and bandwidth performance deterioration.

Therefore, there is a need for more efficiently generating and transmitting the packet when transmitting the data to the user area, without copying the data in the kernel area of the host device or the internal memory of the TOE.

### SUMMARY OF THE INVENTION

Accordingly, an object of the present invention is to generate and transmit a packet without copying the data to the kernel area of the host device or the internal memory of the TOE so as to achieve high capability of the TOE.

Another object of the present invention is to solve conventional time delays for transmitting the packet and the problem of bandwidth performance so as to efficiently generate and transmit the packet.

In accordance with an aspect of the present invention, there is provided a TCP/IP Offload Engine (TOE) apparatus including: an embedded processor for receiving information on an address and size of physical memory and generating a prototype header according to contents of the received information; and Gigabit Ethernet for generating header information of a packet using the prototype header, receiving data according to the address and size of the physical memory included in the information received from a host device through a main PCI bus, a PCI-to-PCI bridge, and a sub PCI bus, and adding the header information to the data, so as to transmit the data to a network.

In accordance with another aspect of the present invention, there is provided a TCP/IP Offload Engine (TOE) apparatus including: an embedded processor for receiving information on an address and a size of physical memory and generating a prototype header according to contents of the received information; a storage unit for storing the prototype header generated in the embedded processor; Gigabit Ethernet for generating header information of a packet using the prototype header stored in the storage unit, receiving data of a user area according to the address and size of the physical memory included in the information received from a host device, and adding the header information on the data, so as to transmit the data to the network; a DMA controller for controlling data transmission between a physical memory area and a storage area; and an internal bus for connecting the embedded processor and the storage unit.

In accordance with an aspect of the present invention, there is provided a method for transmitting a packet, including the steps of: (a) receiving information on an address and a size of a physical memory by an embedded processor; (b) generating a prototype header according to contents of the received information by the embedded processor; (c) generating header information on the packet using the prototype header by Gigabit Ethernet; and (d) receiving data according to the address and size of the physical memory included in the information received from a host device through a main PCI bus, a PCI-to-PCI bridge, and a sub PCI bus and adding the header information to the data so as to transmit the data to a network by the Gigabit Ethernet.

In accordance with an aspect of the present invention, there is provided a method for transmitting a packet, including the steps of: (A) generating, if information on an address and a size of a physical memory is transmitted to an embedded processor, a prototype header based on the received information; (B) notifying Gigabit Ethernet of a location of the generated prototype header and contents included in a list; (C) generating header information of the packet using the prototype header received through DMA by the Gigabit Ethernet; and (D) receiving data according to the address and size of the physical memory included in the information received from a host device and adding the header information to the data so as to transmit the data to a network by the Gigabit Ethernet.

### BRIEF DESCRIPTION OF THE DRAWINGS

FIGS. 1 and 2 are diagrams illustrating the packet transmission using a conventional TOE (INIC);

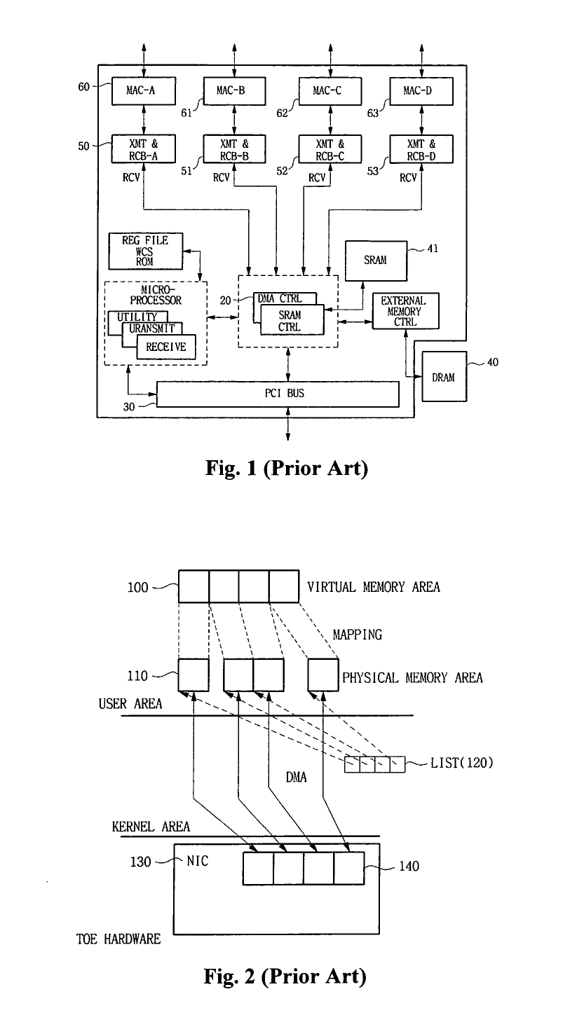

FIG. 3 is a diagram illustrating a TOE apparatus and a method of transmitting the packet using the TOE apparatus without copying the data to an internal of the TOE according to an exemplary embodiment of the present invention; and

FIG. 4 is a flowchart illustrating a method for transmitting the packet using the TOE apparatus according to an exemplary embodiment of the present invention.

### DETAILED DESCRIPTION OF THE EXEMPLARY EMBODIMENTS

Hereinafter, an advantage, characteristic, and method for achieving them will become apparent from the reference of the following exemplary embodiments, in conjunction with the accompanying drawings. However, the present invention is not limited to the embodiments but may be implemented into different forms. These embodiments are provided only for illustrative purposes and for full understanding of the scope of the present invention by those skilled in the art. Throughout the drawings, like elements are designated by like reference numerals.

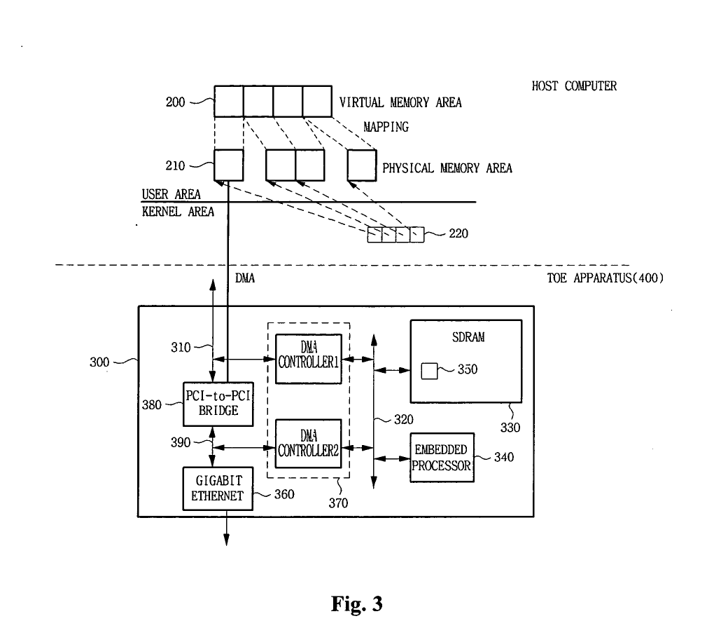

FIG. 3 is a diagram illustrating a TOE apparatus and a method of transmitting a packet using the TOE apparatus without copying the data in an internal of the TOE according to an exemplary embodiment of the present invention.

Hereinafter, in a scheme for processing the TCP/IP of a computer network protocol by the network adapter (TOE) embedded in a computer, a process of transmitting the packet without copying the data to the internal of the TOE upon transmitting the data will be described in more detail through the exemplary embodiment of the present invention. According to the exemplary embodiment of the present invention, the packet can be transmitted without the data being copied to not only a kernel area of a host device, but also an internal memory of the TOE.

As shown in FIG. 3, the TOE apparatus 400 includes SDRAM 330, an embedded processor 340, Gigabit Ethernet 360, a DMA controller 370, and a PCI-to-PCI bridge 380. Hereinafter, the packet transmission using the TOE apparatus 400 together with each element will be described in more detail.

The data in a user area of the host device (host computer) is stored in a virtual sequential memory area 200. The virtual sequential memory area 200 is mapped on a physical memory area 210 being separated in actual. In the exemplary embodiment of the present invention, when transmitting the data of the user area, a list 220 including information on an address and a size of the actual memory is generated so that the data is transmitted to the TOE 300, without copying the data to the kernel area of the host device.

The conventional scheme receives the list 220 and then DMA transfers the data to the internal memory of the TOE. However, in the exemplary embodiment of the present invention, the embedded processor 340 receives the list 220 and then generates a prototype header 350 according to contents of the list 220. Then, the SDRAM 330 performs a function of a storage unit (module) for storing the generated information. The SDRAM 330 can be implemented by at least one from a nonvolatile memory device, such as cash, ROM (Read Only Memory), PROM (Programmable ROM), EPROM (Erasable Programmable ROM), EEPROM (Electrically Erasable Programmable ROM), and flash memory, or a volatile memory device, such as RAM (Random Access Memory), but it is not limited thereto.

The prototype header 350 includes information required for constructing a header portion of each packet when the packet is transmitted through the Gigabit Ethernet 360.

After the prototype header 350 is generated, the embedded processor 340 notifies the Gigabit Ethernet 360 of a location of the prototype header 350 (i.e. a memory address of the SDRAM) and contents included in the list 220. Here, the notification can be implemented through describing the value to a specific register of the Gigabit Ethernet 360.

Then, the Gigabit Ethernet 360 receives the prototype header 350 through DMA, identifies the contents of the prototype header 350, and generates header information of the packet using the prototype header 350.

Further, the Gigabit Ethernet 360 receives through DMA the data of the user area (the data included in the physical memory area 210) according to the contents of the list 220, i.e. the address and size of the actual memory with respect to the data to be transmitted, using a main PCI bus 310, the PCI-to-PCI bridge 380, and a sub PCI bus 390.

Here, the main PCI bus 310 connects the host device (computer) and the TOE apparatus 400. The PCI-to-PCI bridge 380 can be used upon installing the PCI devices in the internal of the TOE, and the TOE apparatus 400 according to the exemplary embodiment of the present invention includes the Gigabit Ethernet. Further, the sub PCI bus 390 can be used for connecting the Gigabit Ethernet 360 and the PCI-to-PCI bridge 380. Therefore, the Gigabit Ethernet 360 requests the DMA of the data of the host computer, the data is shifted to the main PCI bus 310, the PCI-to-PCI bridge 380, and the sub PCI bus 390 in sequence, to reach.

Further, the DMA controller 370 can be used for transmitting the data between the physical memory area 210 and the SDRAM 330 area of the TOE apparatus 400. An internal bus 320 connects the embedded processor 340 and the SDRAM 330.

If a size of the corresponding data is smaller than that of a single packet, the Gigabit Ethernet 360 adds the packet header generated based on the prototype header 350 to the front of the data of the packet while receiving the data through DMA so as to transmit the packet data to the network. Further, if a size of the corresponding data is larger than that of a single packet, the Gigabit Ethernet 360 splits the data in a size of the packet and adds the packet header to the front of each packet data, so as to transmit the packet data to the network.

Through the described scheme, the Gigabit Ethernet 360 generates the packet so as to directly transmit the packet to the network, without copying the data to the internal memory 330 of the TOE.

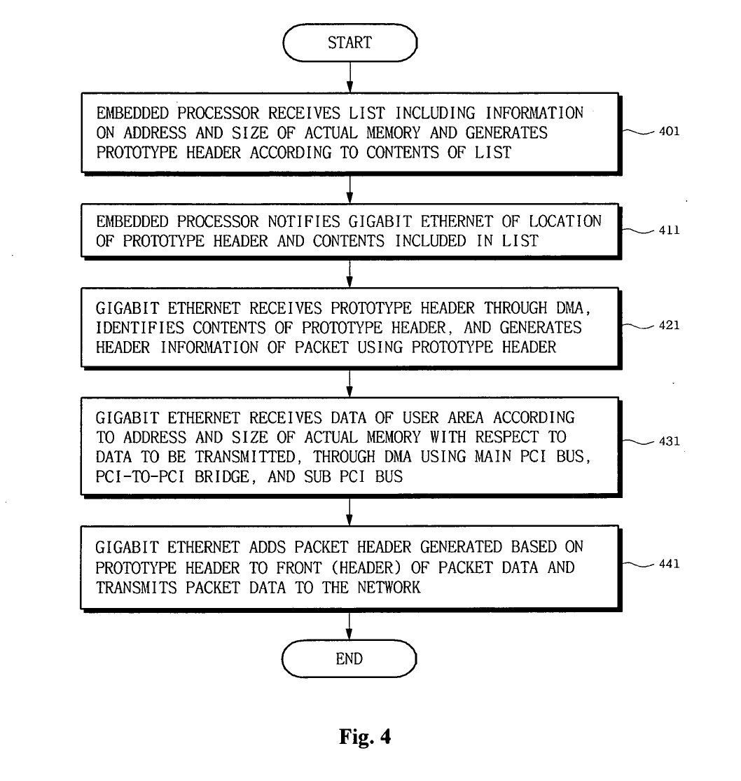

FIG. 4 is a flowchart illustrating a method for transmitting the packet using the TOE apparatus according to an exemplary embodiment of the present invention.

First, the embedded processor 340 receives the list 220 including information on the address and size of the actual memory and generates the prototype header according to the contents of the list 220 S401. Here, the prototype header is the header including TCP/IP information required for receiving the data through DMA and packetizing it by the Gigabit Ethernet according to the contents of the list. Then, the SDRAM 330 stores the generated information.

Further, the embedded processor 340 notifies the Gigabit Ethernet 360 of the location in the memory including the prototype header 350 and the contents included in the list 220 S411.

Next, the Gigabit Ethernet 360 receives the prototype header 350 through DMA, identifies the contents of the prototype header 350, and generates the header information of the packet using the prototype header 350 S421.

Further, the Gigabit Ethernet 360 receives through DMA the data of the user area according to the contents of the list 220, i.e. the address and size of the actual memory with respect to the data to be transmitted, using the main PCI bus 310, the PCI-to-PCI bridge 380, and the sub PCI bus 390 S431. That is, the data of the user area is scattered in the physical memory area, so the Gigabit Ethernet receives the data with the information on each start location and the size of the memory area through DMA, stores the data in an internal buffer of the Gigabit Ethernet, and packetizes the data, so as to transmit the packet data to the network.

Then, the Gigabit Ethernet 360 adds the packet header generated based on the prototype header 350 to the front (header) of the data of the packet, i.e. packet header processing, so as to transmit the packet data to the network S441. Here, if a size of the corresponding data is smaller than that of a single packet, the Gigabit Ethernet 360 adds the packet header generated based on the prototype header 350 to the front of the data of the packet, while if a size of the corresponding data is larger than that of a single packet, the Gigabit Ethernet 360 splits the packet in the size of the packet and adds the packet header to the front of each packet data so as to transmit the packet data to the network. Here, the data can be split in accordance with Maximum Transmission Unit (MTU) size.

Each element shown in FIG. 3 can be a kind of ‘module’. The ‘module’ refers to software or a hardware element, such as Field Programmable Gate Array (FPGA) or Application Specific Integrated Circuit (ASIC), and performs a specific function. However, the module is not limited to software or hardware. The module can be included in an addressable storage medium and can be constructed to execute one or more processors. The functions provided from the elements and modules can be implemented with the less number of constructional elements or modules or can be further separated into the additional constructional elements or modules.

As described above, the TOE apparatus and the method for transmitting the packet using the TOE apparatus of the present invention has an advantage of solving the conventional problems of time delays occurring during copying the data to the kernel area of the host device or the internal memory of the TOE and bandwidth performance so as to directly generate and transmit the packet.

Through the above description, it will be understood by those skilled in the art that various changes and modifications can be made thereto without departing from the technical spirit and scope of the present invention. Therefore, the embodiment described above is only for example in every aspect, and is not limited thereto.

What is claimed is:

1. A TCP/IP Offload Engine (TOE) apparatus comprising:
an embedded processor for receiving information on an address and size of physical memory and generating a prototype header according to contents of the received information; and
Gigabit Ethernet for generating header information of a packet using the prototype header, receiving data according to the address and size of the physical memory included in the information received from a host device through a main PCI bus, a PCI-to-PCI bridge, and a sub PCI bus, and adding the header information to the data, so as to transmit the data to a network.

2. The TOE apparatus as claimed in claim 1, wherein the PCI-to-PCI bridge is positioned between the main PCI bus and the sub PCI bus for connecting the host device and the TOE.

3. The TOE apparatus as claimed in claim 2, wherein the Gigabit Ethernet is connected with the PCI-to-PCI bridge through the sub PCI bus.

4. A TCP/IP Offload Engine (TOE) apparatus comprising:
an embedded processor for receiving information on an address and a size of physical memory and generating a prototype header according to contents of the received information;
a storage unit for storing the prototype header generated in the embedded processor;
Gigabit Ethernet for generating header information of a packet using the prototype header stored in the storage unit, receiving data of a user area according to the address and size of the physical memory included in the information received from a host device, and adding the header information on the data, so as to transmit the data to the network;
a DMA controller for controlling data transmission between a physical memory area and a storage area; and
an internal bus for connecting the embedded processor and the storage unit.

5. The TOE apparatus as claimed in claim 4, wherein the storage unit includes any one of a nonvolatile memory device and a volatile memory device.

6. The TOE apparatus as claimed in claim 4, wherein, if the packet is transmitted through the Gigabit Ethernet, the prototype header includes information required for constructing a header portion of each packet.

7. The TOE apparatus as claimed in claim 4, wherein the Gigabit Ethernet receives the data of the user area through a main PCI bus, a PCI-to-PCI bridge, and a sub PCI bus.

8. The TOE apparatus as claimed in claim 7, wherein the main PCI bus connects the host device and the TOE apparatus.

9. The TOE apparatus as claimed in claim 7, wherein the PCI-to-PCI bridge is used for installing PCI devices in an internal of the TOE.

10. The TOE apparatus as claimed in claim 7, wherein the sub PCI bus connects the Gigabit Ethernet and the PCI-to-PCI bridge.

11. The TOE apparatus as claimed in claim 7, wherein, if the Gigabit Ethernet requests DMA of the data of the host device, the data is shifted to the main PCI bus, the PCI-to-PCI bridge, and the sub PCI bus in sequence to reach.

12. A method for transmitting a packet, comprising the steps of:
(a) receiving information on an address and a size of a physical memory by an embedded processor;
(b) generating a prototype header according to contents of the received information by the embedded processor;
(c) generating header information on the packet using the prototype header by Gigabit Ethernet; and
(d) receiving data according to the address and size of the physical memory included in the information received from a host device through a main PCI bus, a PCI-to-PCI bridge, and a sub PCI bus and adding the header information to the data so as to transmit the data to a network by the Gigabit Ethernet.

13. The method as claimed in claim 12, wherein step (c) comprises a step of receiving the prototype header through DMA by the Gigabit Ethernet.

14. A method for transmitting a packet, comprising the steps of:
(A) generating, if information on an address and a size of a physical memory is transmitted to an embedded processor, a prototype header based on the received information;
(B) notifying Gigabit Ethernet of a location of the generated prototype header and contents included in a list;
(C) generating header information of the packet using the prototype header received through DMA by the Gigabit Ethernet; and
(D) receiving data according to the address and size of the physical memory included in the information received from a host device and adding the header information to the data so as to transmit the data to a network by the Gigabit Ethernet.

15. The method as claimed in claim 14, wherein the notifying in step (B) is implemented through describing a value to a specific register of the Gigabit Ethernet.

16. The method as claimed in claim 14, wherein the generating the header information of the packet in step (C) comprises the steps of:
adding the packet header generated based on the prototype header to a front of the packet data if a size of the data received through DMA is smaller than that of a single packet; and
splitting the data in a size unit of a packet if a size of the data received through DMA is larger than that of a single packet and adding the packet header to the front of each packet data.

17. The method as claimed in claim 16, wherein the data is split in a size unit of the packet in accordance with Maximum Transmission Unit (MTU) size.

18. The method as claimed in claim 14, wherein, in step (D), the data is received through a main PCI bus, a PCI-to-PCI bridge, and a sub PCI bus.

19. The method as claimed in claim 14, wherein, in step (D), the Gigabit Ethernet receives the data with information on each start location and a size of a memory area through DMA, stores the data in an internal buffer of the Gigabit Ethernet, and packetizes the data so as to transmit the data to the network.

20. The method as claimed in claim 14, wherein, in step (D), the data is transmitted to the network through the generated packet header being added to a front (header) of the data of the packet.
